(19) United States
(12) Patent Application Publication
(10) Pub. No.: US 2013/0117072 A1
(43) Pub. Date: May 9, 2013

(54) SYSTEM AND METHOD FOR MEASURING AND DISPLAYING RESIDENTIAL REAL ESTATE AND PROPERTY VALUES

(71) Applicant: Ryan Nish, Hoboken, NJ (US)

(72) Inventor: Ryan Nish, Hoboken, NJ (US)

(21) Appl. No.: 13/667,647

(22) Filed: Nov. 2, 2012

Related U.S. Application Data
(60) Provisional application No. 61/555,891, filed on Nov. 4, 2011.

(51) Int. Cl. G06Q 50/16; G06Q 30/02

(52) U.S. Cl. 705/7.33

(57) ABSTRACT

A system and a method for displaying real estate information include a display illustrating a heat map generated from at least one database. The at least one database includes objective data about plurality of real estate properties. The heat map providing a comparative market analysis for a desired location selected by an end user.

### CROSS-REFERENCE TO RELATED APPLICATION

This application claims priority to U.S. Provisional Application Ser. No. 61/555,891, filed Nov. 4, 2012, the entire disclosure of which is hereby incorporated herein by reference.

### FIELD OF INVENTION

The present disclosure relates to a system and a method for displaying real estate property values and, more particularly, to a system and a method for displaying real estate property values using a heat map.

### BACKGROUND OF THE INVENTION

Purchasing real estate property can be a difficult and confusing task due to the many factors involved in evaluating properties available for purchase. For example, potential condominium and single family home buyers often look for properties listed at a reasonable price based on the location and/or the size of the home (square footage). Other factors may be equally important to potential home buyers such as the amount of annual taxes owed, the amount of monthly maintenance fees due, the amount of homeowner's association fees due, and the number of bedrooms and/or bathrooms. Additionally, it can be difficult for potential home buyers to determine whether an asking price of a property is high or low compared to other properties in the same area.

There are systems available to potential home buyers for determining whether a property has certain desirable factors. However, the available systems are often difficult to navigate and do not provide sufficient detail with respect to comparative data for properties in a particular geographic area. Additionally, the available systems do not provide any indication whether a value based on the asking price per square foot for a particular property is reasonable or excessive.

It is desirable to have a system and method for displaying real estate information that is easy to use, compares objective real estate values including asking price per square foot, and allows a user to determine a fair market value for properties in a specific geographic area.

### SUMMARY OF THE INVENTION

Consonant with the instant disclosure, a system and method for displaying real estate information that is easy to use, compares objective real estate values including asking price per square foot, and allows a user to determine a fair market value for properties in a specific geographic area, has surprisingly been discovered.

In a particular embodiment of the disclosure, the design and display structure of the invention is on a website or mobile application and is intended to measure real estate (real property) values in a manner in which the web- or app- (application) user (referred to herein as “end user”) can interactively search for active homes for sale or previously sold homes and be graphically informed of those home values in an effort to improve his/her judgment of the property market. This invention is also useful in an effort to produce sales leads to Real Estate Agents in which the end user would contact the producer of this website/app or its associates in an effort to find out more information on and/or facilitate the purchase of a home as a consumer/investor in Real Estate. A comparable market analysis is performed between active sales listings or sold homes to find the relative value of comparables or “comps”. Prospective home buyers can determine and analyze higher concentrations of homes that are priced similarly in value, sometimes used to determine fair market value, and also outliers that are priced more expensively, and outliers that are priced less expensively. They can use this information to their advantage in that they can avoid choosing an outlier home that is more expensive in asking price per squire foot and/or monthly maintenance fees per square foot, or in turn, find and pay less for a less expensively priced home in the same objective manner.

To achieve the graphical display, the asking prices or selling prices of the single family home or condominium classes are measured by producing a price per square foot calculation of the property, which is achieved by dividing the asking price or selling price of the home listed for sale or previously sold from data provided by the Multiple Listing Service (“MLS”), or alternative data sources such as syndication data methods, by the square footage of the home through an automated process. Then this number is displayed on the Y-axis of the graph in a set range of prices per square foot in increasing value differentiated by rows. Next, in the case of condominium class of home, for example, the X-axis is a display of the monthly maintenance fees charged by the condominium association in a set range of costs in increasing value displayed in columns. The data from the database can be filtered, calculated, and aggregated according to the end users specifications. These include, for example, number of bedrooms, overall square footage minimum/maximum, price range, city/town, and number of bathrooms. The data is accumulated and displayed in the cells as a “headcount” of matching properties correlating to the columns and rows in the appropriate ranges.

Additionally, besides the numerical representation displayed by the “headcount”, the color of the cells are variable and represent a “heat mapping” function that graphically displays the overall percentage of condos for sale for that particular range out of the pool of the specified data set using a map key display. The higher the concentration of properties in a cell, the darker the shade of the displayed color that cell receives. The end user can then click the hyperlink “headcount” numbered cell to proceed to view more details about that particular value “numbered” set and/or to contact a real estate agent or broker for a showing appointment. Home descriptions, asking prices, square footage, taxes, pictures, and any other applicable IDX MLS or syndicated data may be displayed in accordance to the National Association of Realtors rules and regulations.

In contrast, for the Single Family home class, where the end user can choose between “condo” and single family home, the homebuyer will see a different X-axis which compares the annual municipal property taxes instead of monthly maintenance fees. The Y-axis remains the price per square foot of the home for both classes/property types. The same principles of measuring described above apply.

The graphical “heat map” representation of the present disclosure serves to visually “commoditize” real estate properties, by stripping them down into objective value groupings according to the asking price per square foot and the fees and/or taxes associated with owning them. The graph and data together measure relative home values for the end user in three different ways in one glance. Those are price per square foot, monthly fees/annual property taxes and the concentration of homes in a particular data set as compared to the overall market or “end user” specified criteria using the “headcount” and heat map. The heat map serves prospective home purchasers and guides them to make decisions objectively on property before the home purchasers physically and subjectively look at pictures or tour a home. Prospective home sellers can also use this invention to become aware of market conditions and at what price levels whether their local home market is pricing comparable homes, so they can sell their home more quickly by pricing in line with buyer expectations.

In one embodiment, a system for displaying real estate information includes a display on which a heat map is presented. The heat map is generated from at least one database. The at least one database includes objective data about a plurality of real estate properties. The heat map provides a comparative market analysis for at least one user requirement, such as a desired location, selected by an end user.

In another embodiment, a system for displaying real estate information includes a server having a processor for executing instructions to present the real estate information. The server also has a memory in communication with the processor. The memory includes at least one database with the real estate information. The system also includes a user interface including a display and an input device in communication with the processor via a network. The display presents the real estate information in the form of a heat map. The heat map has a first axis representing a range of property value characteristics of a plurality of real estate properties and a second axis representing a range of additional costs associated with the a plurality of real estate properties. The input device permits a user to generate the heat map based on the real estate information stored in the database. The system also includes one or more user requirements based on the objective data that may be selected by the user.

In yet another embodiment, a method for displaying real estate information comprises the steps of: permitting a user to select one or more user requirements relating to the plurality of real estate properties; performing a search of a database including objective information for the plurality of real estate properties based on the user requirements; and generating a heat map displaying the real estate information based on the search of the database, where a first identifying characteristic is represented on a first axis and a second identifying characteristic is represented on a second axis.

### DRAWINGS

The above, as well as other advantages of the present disclosure, will become readily apparent to those skilled in the art from the following detailed description, particularly when considered in the light of the drawings described hereafter.

FIG. 1 is a schematic diagram of a system for displaying real estate information according to one embodiment of the disclosure;

FIG. 2 is a screenshot of the display generated by the system of FIG. 1;

FIG. 3 is another screenshot of the display generated by the system of FIG. 1;

FIG. 4 is yet another screenshot of the display generated by the system of FIG. 1;

FIG. 5 is a flow diagram of a method for displaying real estate information according to an embodiment of the disclosure;

FIG. 6 is a flow diagram of a method for displaying real estate information according to another embodiment of the disclosure;

FIG. 7 is a screenshot of a display generated by the system according to an alternate embodiment of the invention;

FIG. 8 is another screenshot of the display generated by the system of FIG. 7, showing instructions for selecting user requirements;

FIG. 9 is another screenshot of the display generated by the system of FIG. 7, showing objective data for a selected property; and

FIG. 10 is a screenshot of a display generated by the system of FIG. 7, the display showcasing the selected property of FIG. 9.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the present disclosure, application, or uses. It should also be understood that throughout the drawings, corresponding reference numerals indicate like or corresponding parts and features.

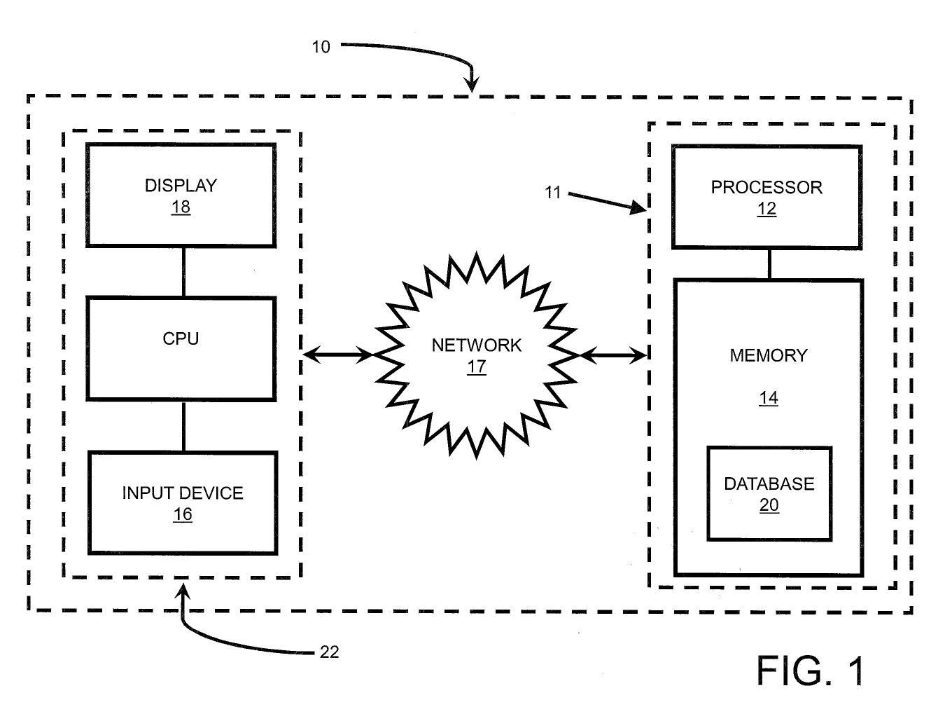

FIG. 1 illustrates a system 10 for displaying real estate values. The system 10 includes a server 11 and a user interface 22 such as a personal computer. The user interface 22 may include an input device 16 and a display 18. The user interface 22 is in communication with the server via a network 17, for example, the Internet. The system 10 presents real estate information for real estate properties available for purchase and organizes the real estate information into a heat map based on objective data when prompted to perform a search by a user.

The server 11 may be any hardware server or program capable of storing and managing the objective data such as a web server, for example. The server 11 may download and saves the objective data to the memory 14, either automatically or when prompted to from real estate listing services such as the National Association of Realtors Multiple Listing Service or third party syndication services, for example. The objective data may be downloaded once daily or more or less often, as desired. The objective data is used to provide the user with the real estate information that is generated on the display 18

The server 11 may include a processor 12 and a memory 14. The processor 12 may be a central processing unit (CPU), for example, or any other type of processor configured to execute instructions for presenting the real estate information. Advantageously, the processor 12 executes instructions for presenting the real estate information in the form of the heat map as described further herein.

The memory 14 is in communication with the processor 12. The memory 14 includes a computer-readable data file of stored information such as at least one database 20 that stores the objective data associated with each property available for purchase. The objective data may include a sale price or a square footage of each property available for purchase, for example. The database 20 may also store objective data for properties previously sold.

In particular embodiments, the user interface 22 is in communication with the processor 12 via the network 17. The user interface 22 permits the user to select specific objective data from the database 20 on which the search is based. In certain embodiments, the input device 16 and the display 18 are provided together as a single or unitary user interface 22. For example, the user interface 22 may be a touch screen display, or a mechanical device such as a mouse or keyboard, for example, that is separate from the display 18 and permits a user to interact with the system 10.

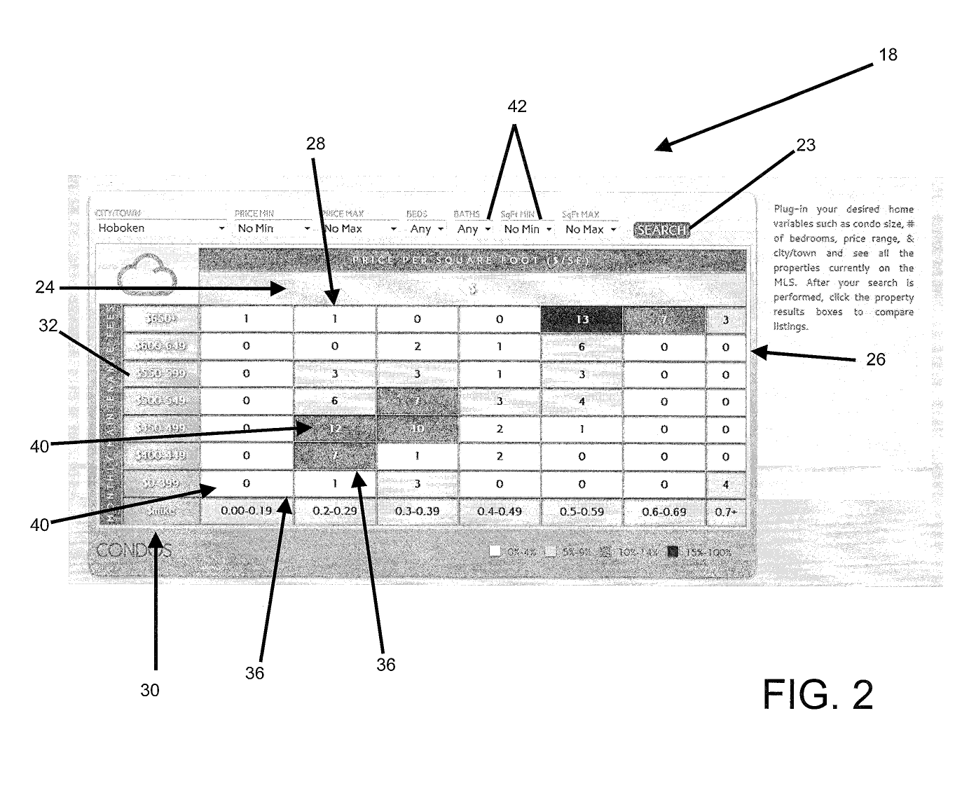

Advantageously, and as shown in FIGS. 2, 3, and 4, the display 18 according to the present disclosure depicts a heat map. Although the heat map shown in FIG. 2 relates to specifically to condominium information, it should be understood that the heat map according to the present disclosure may likewise be generated relative to information about other types of real property such as single family homes and apartments, as nonlimiting examples.

The heat map may present select specific objective data in the form of a grid, a chart, a diagram, or other visual display. The heat map may also include any combination of words, numbers, symbols, or other indicia that convey information to the user. As nonlimiting examples, the display 18 is provided as a computer monitor or a video screen onto which the heat map is generated and displayed. The user may access the system 10 and observe the heat map on an Internet website, a mobile phone application, or other device, as desired.

The heat map generated on the display 18 may include a first axis 24. The first axis 24 presents an identifying characteristic such as a range of real estate values, for example. Each property available for purchase has an associated value within the range of values represented along the first axis 24. The value of each property may be based on the sale price of the property, or, as shown in FIGS. 2, 3, and 4, the sale price of the property divided by the square footage of the property. It is understood that the value of each property may be based on other factors, as desired. The basis for the value associated with each property and/or the range of values displayed along the first axis 24 may be predetermined or selected by the user using the user interface 22. The heat map may include one or more headings 26 along the first axis 24 that identify the basis for the value associated with each property, the range of values presented in the display 18, and/or the increments in which the values are represented. Increments represented along the first axis 24 may be divided into columns 28, or rows, and may be displayed in increasing intervals or decreasing intervals, as desired.

The heat map depicted on the display 18 also includes a second axis 30. The second axis 30 presents an identifying characteristic such as a range of additional costs, for example. Each property available for purchase may have the additional costs associated with ownership of the property. A basis for the additional costs for each property may be yearly taxes, monthly maintenance fees divided by square footage, or monthly maintenance fees such as utility-based fees, parking fees, and home owner association fees, for example. It is understood that the additional costs associated with each property may be based on other fees and/or required payments, as desired. The additional costs included and/or the range of additional costs displayed along the second axis 30 may be predetermined or selected by the user employing the user interface 22. The display 18 may include one or more headings 32 along the second axis 30 that identify the type of additional costs, the range of additional costs presented in the display 18, and/or the increments in which the additional costs are represented. Increments represented along the second axis 30 may be divided into rows 34, or columns, and may be displayed in increasing intervals or decreasing intervals, as desired.

The heat map described above, and shown in FIGS. 2, 3, and 4, has the first axis 24 as an X-axis with increments divided into the columns 28, and the second axis 30 as a Y-axis with increments divided into the rows 34. However, it should be understood that the first axis 24 may alternatively be the Y-axis and the second axis 30 may alternatively be the X-axis, as desired. Other configurations for the first axis 24 and the second axis 30, including non-perpendicular and non-Euclidean configurations, are also within the scope of the present disclosure.

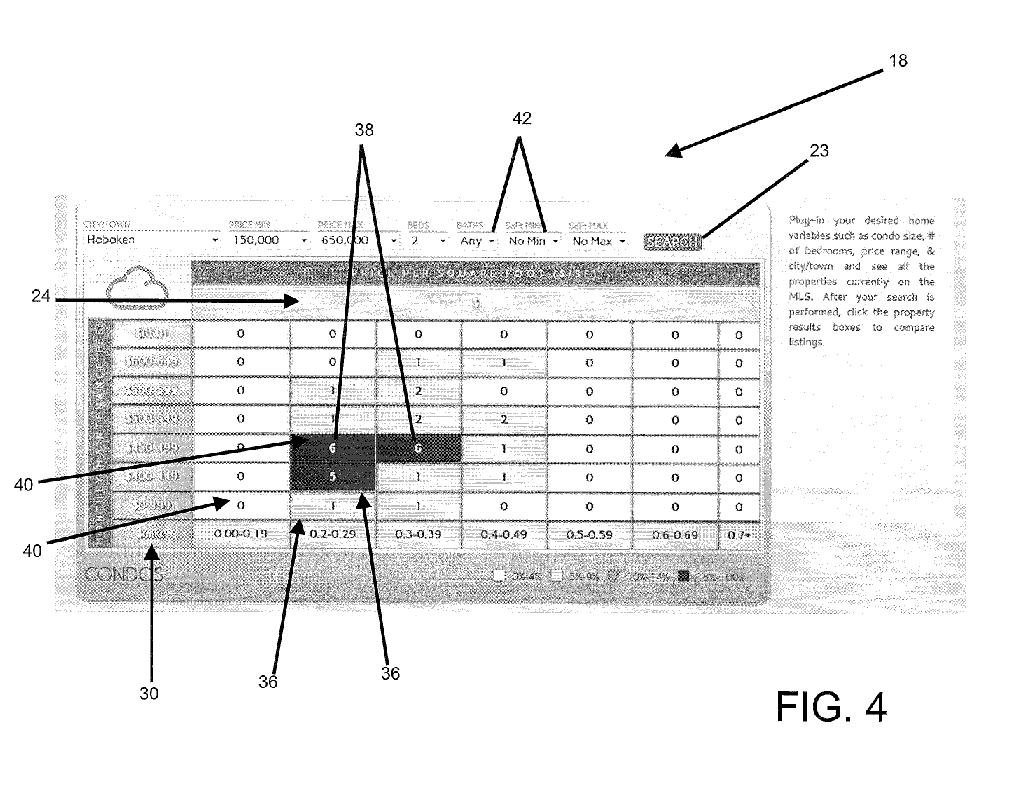

The heat map on the display 18 also includes a plurality of cells 36. Each of the cells 36 is formed at an intersection between a column 22 along the first axis 24 and a row 26 along the second axis 30. When the user performs a search, each cell 36 is populated with an output 38 (see FIG. 4). In certain embodiments of the disclosure, each output 38 represents a total number of properties having a specific value along the first axis and a specific value along the second axis that correspond with the cell in which the output is displayed.

Each cell 36 may also have a background 40 with a specific color or degree of shading. The color or degree of shading may depend on the total number of properties represented in the cell 36. In certain embodiments of the disclosure, the cells 36 displaying a higher total number of properties have backgrounds 40 showing a darker color or a darker degree of shading. Each cell 36 included in the heat map on the display 18 may also provide a hyperlink to another webpage or website that includes detailed listings for each property represented by the selected cell 36.

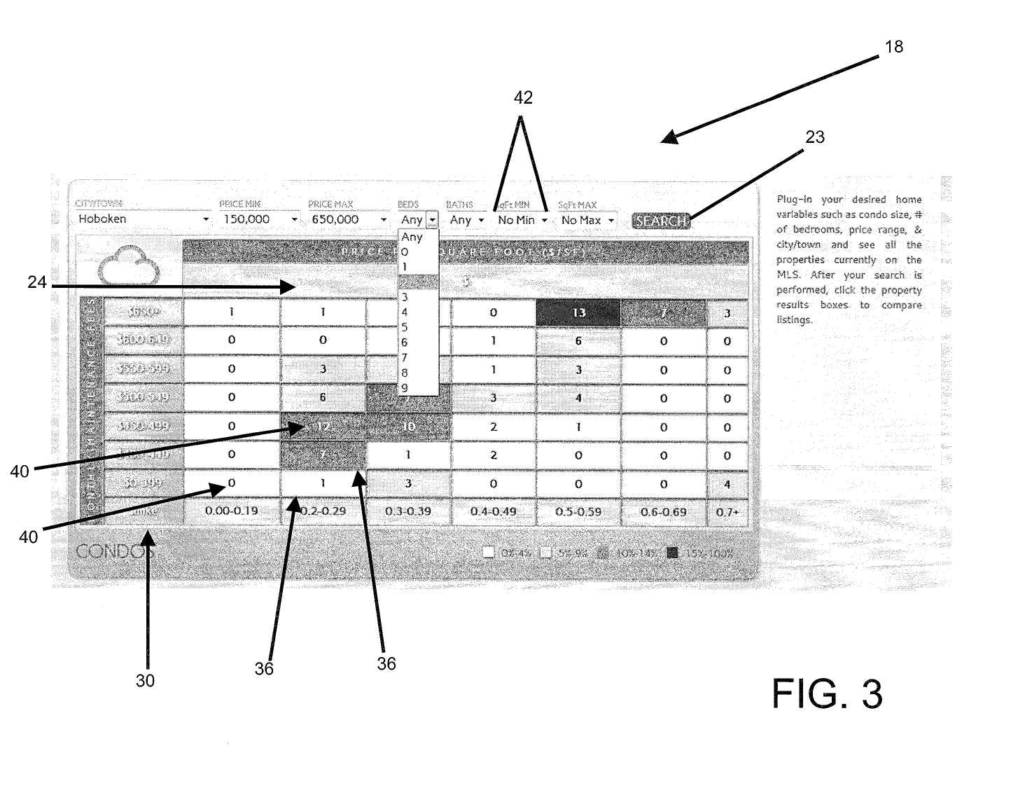

User requirements 42 may be provided on the user interface 22 and allow the user to limit the output 38 of the search based on the objective information about each property. The user requirements 42 may be displayed in the faun of drop down menus 44 on the user interface 22, for example. Each drop down menu 44 may include specific parameters relating to the user requirement 42 under which the specific parameters are listed (see FIG. 3). The user may select the desired user requirements 42 and also select the desired specific parameters 36 from the corresponding user requirement 42 drop down menu 44. The user requirements 42 may include, but are not limited to, a location of the property, a range of asking prices, a desired square footage, a number of bedrooms, and/or a number of bathrooms. In a most particular embodiment, the user requirements 42 include the location of the property, and permit the user to generate a comparative market analysis relative to the location of interest. It is understood that other user requirements 42 may be used to narrow down the properties included in the output 38 of the search.

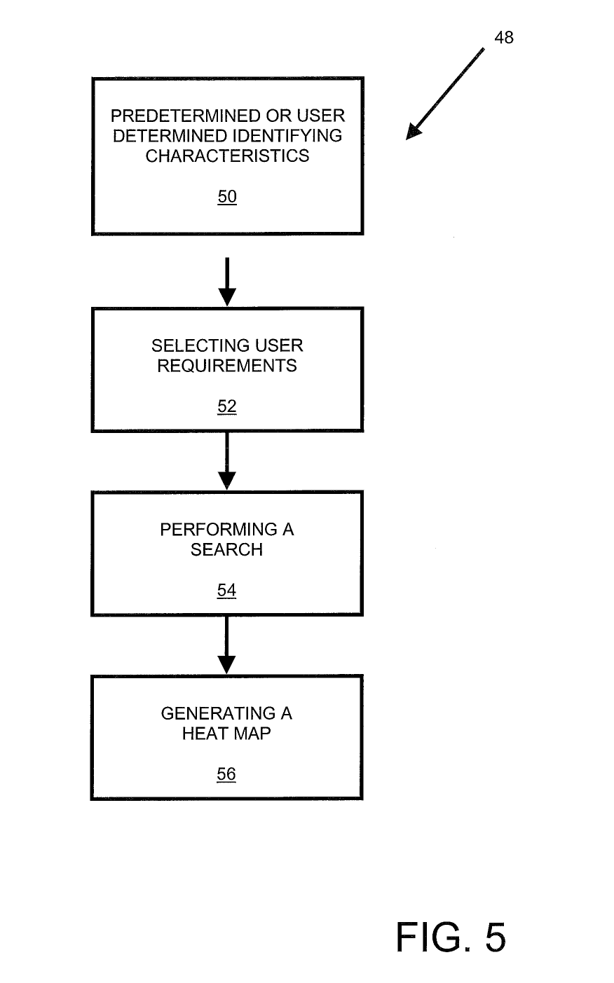

In another embodiment of the disclosure, as shown in FIG. 5, a method 48 for visually displaying the real estate information in the form of the heat map is disclosed. The method 48 may include the system 10 for displaying real estate information described hereinabove. Initially, the identifying characteristics may be predetermined or selected by the user 50. Where predetermined, the identifying characteristics may include a value associated with the property and/or the basis for the additional costs, such as the asking or sale price per square foot and monthly maintenance fees as nonlimiting examples. Where the user is permitted to select the identifying characteristics for the properties, the user may select the basis for the value of the property and/or the basis for the additional costs associated with the property. If the user selects the sale price per square footage basis for the value of the property, a calculation of the sale price per square footage may be performed for each property included in a particular subset of properties or all of the properties included in the database, or the database may already include the value based on the sale price per square footage for each property prior to selection.

The user is also permitted to select from one or more of the user requirements 52 such as a location of the property, a range of asking or sale prices, a desired square footage, a number of bedrooms, and/or a number of bathrooms. The user may also select the specific parameters for one or more user requirements 42, as desired. The user then performs the search of the objective data included in the database 20 in order to limit the objective data to be used in generating the heat map to only those properties 54 based on the selected user requirements 42.

Upon completion of the search, the display 18 is generated in the form of the heat map 56. The heat map 56 on the display 18 may include the predetermined or the selected identifying characteristics represented along the first axis 24 and the second axis 30, as described in further detail hereinabove. Additionally, the heat map 56 may include the output 38 of the total number of properties having the appropriate objective data in each cell 36, and the appropriate color or degree of shading in the background 40 of each cell 36.

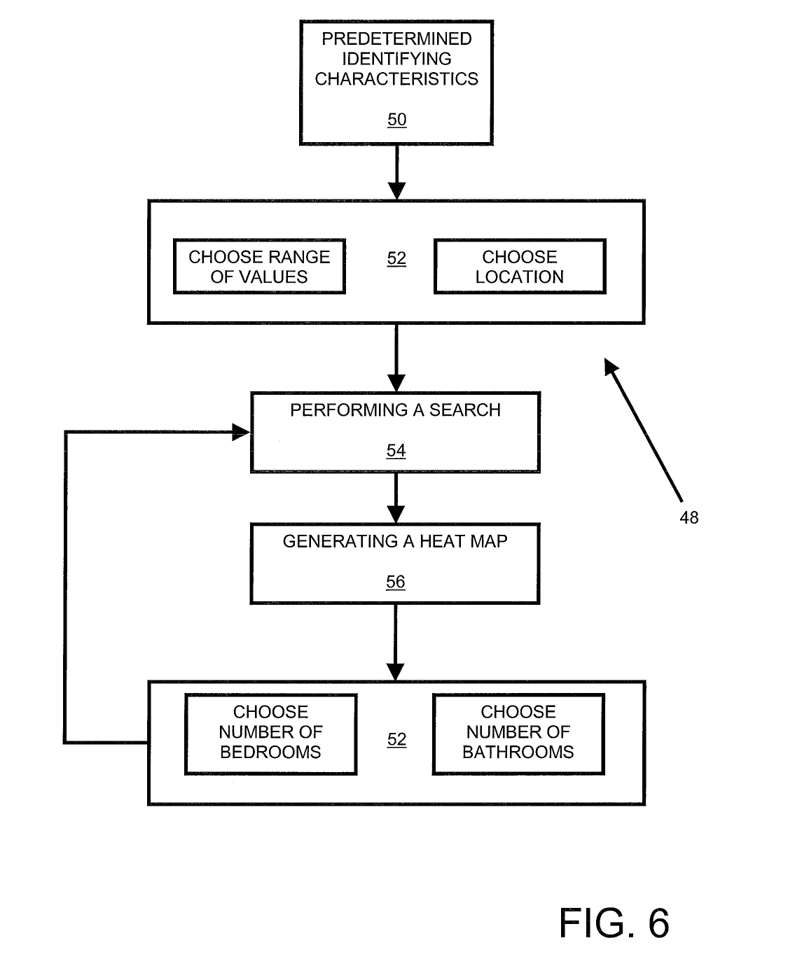

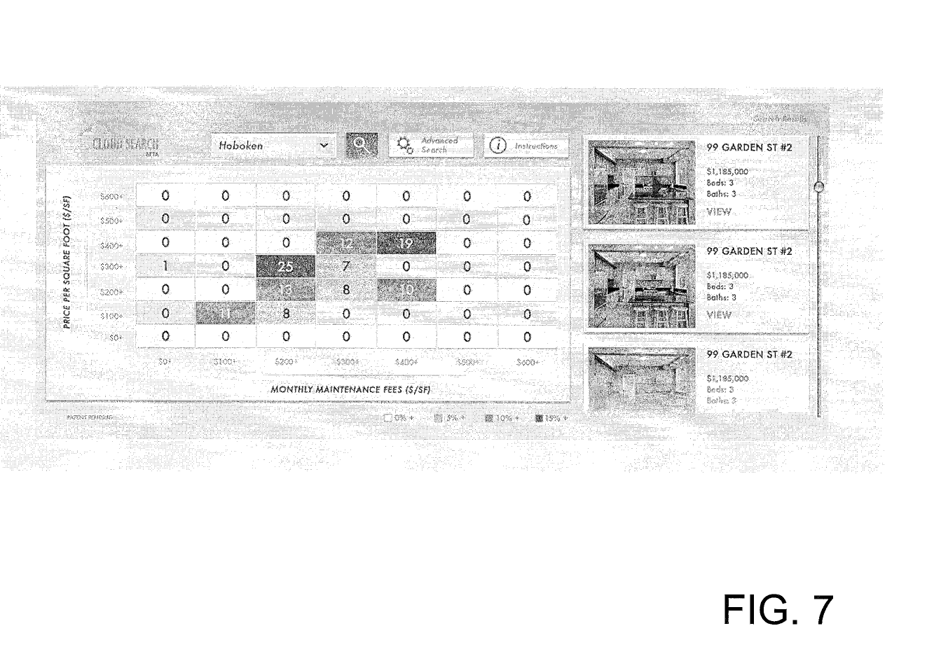

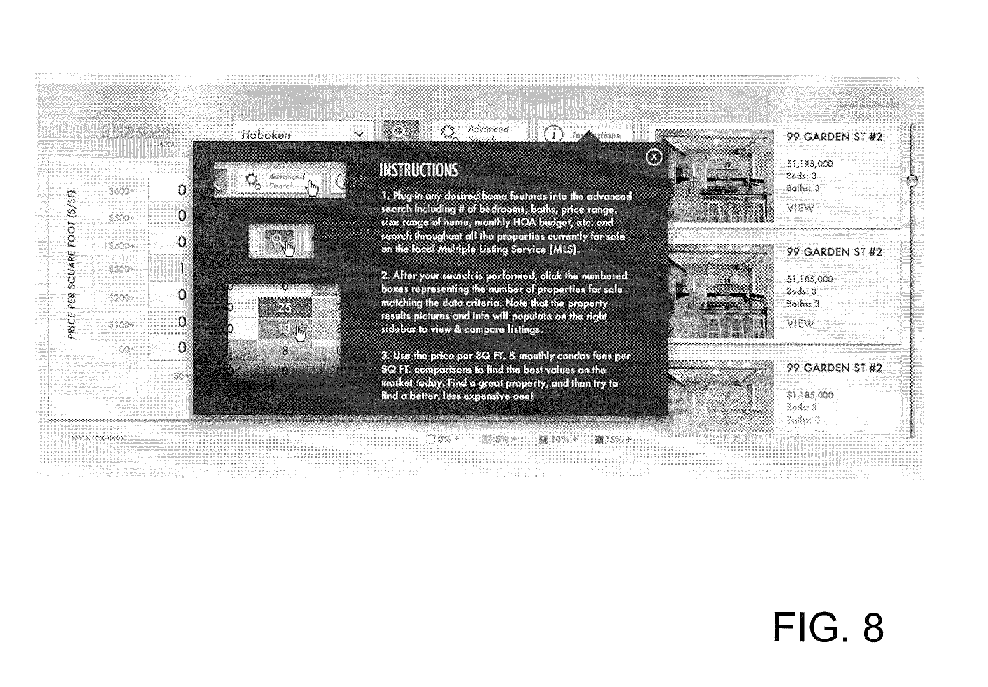

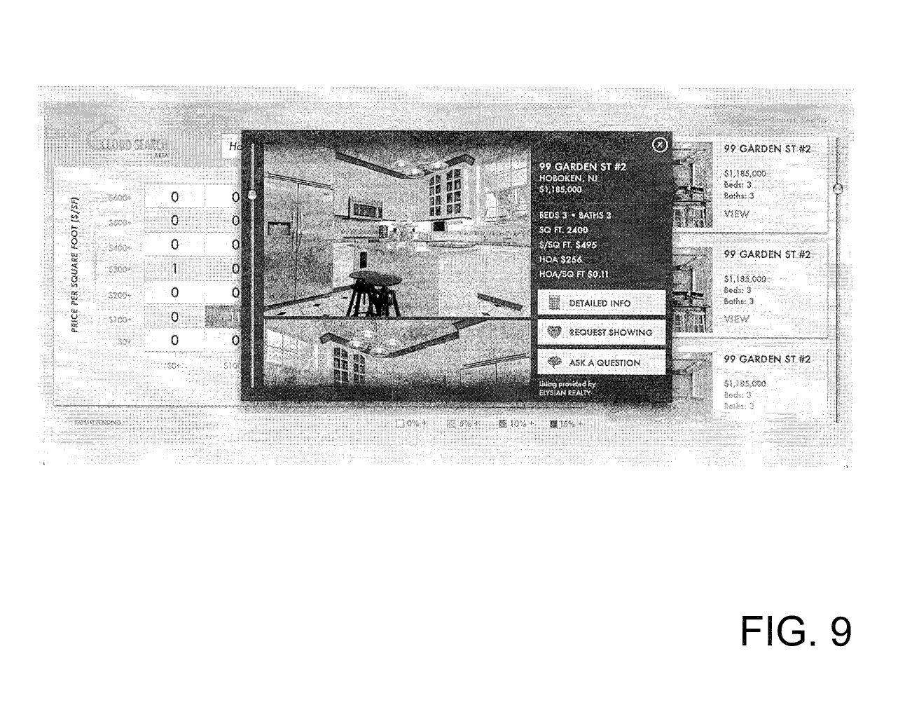

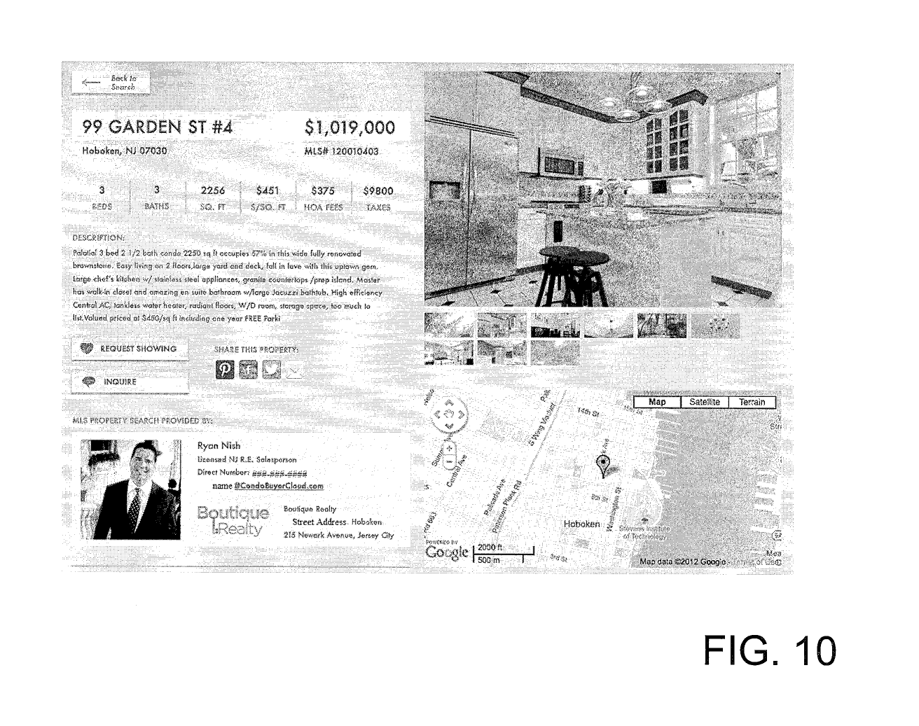

It should be appreciated that the user may evaluate the output 38 and shading in order to identify both properties desirable for their relatively inexpensive attributes, and outlier properties that are undesirable and expensive. The order that, and frequency which, the user selects the identifying characteristics and/or the user requirements 42 and performs the search may vary by search and/or by user. As shown in FIG. 6, in certain embodiments of the invention, the identifying characteristics may be predetermined, and the user may select certain user requirements 42, perform an initial search, and then select additional user requirements 42 in order to further limit the results of the initial search. The user may amend or further limit the search by selecting different identifying characteristics and/or additional or more limiting user requirements 42 at any time. FIGS. 7-10 illustrate alternate embodiments according to the disclosure.

In operation, the user may access and select a geographic location such as a particular neighborhood, city, or county, for example, through the user input device 22. In certain embodiments of the disclosure, the user may also select a type of real estate property such as a residential home or a condominium, for example. Additionally, the user may also select the basis for the value represented along the first axis 24 and/or the type of additional costs represented along the second axis 30. In certain embodiments, the basis for the value and the type of additional costs along the first axis 24 and the second axis 30, respectively, may be predetermined or may be based on the type of real estate property selected by the user. For example, if the user selects residential homes, the first axis 24 may display a range of house values based on the asking or sale price per square foot and the second axis 30 may display a range of yearly taxes due. Alternatively, if the user selects a condominium, the first axis 24 may display a range of condominium values based on asking or sale price per square foot, and the second axis 30 may display a range of additional costs such as utility-based fees, or common charges, for example.

Next, the user may select from the specific parameters under one or more of the user requirements 42 in order to narrow the output 38 of the search. For example, the user may select the user requirement 42 drop down menu 44 relating to a minimum desired square footage of each property and select the desired minimum square footage. By doing so, the output 38 of the search will include only those properties having the desired minimum square footage or more square footage. Likewise, the user may select the user requirement 42 drop down menu 44 relating to a desired maximum square footage of each property and select the desired maximum square footage. By doing so, the output 38 of the search will include only those properties having the desired maximum square footage or less square footage.

The user may then perform the search using the search function 23. The objective data stored in the database 20 is used to populate each cell 36 displayed on the display 18. Specifically, the total number of properties that have objective data stored in the database 20 that matches the value are represented in the corresponding column 22 along the first axis 24, and the additional costs are represented in the corresponding row 26 along the second axis 30. The objective data used to populate each cell is limited by the user requirements 42 specified by the user. The user may select from additional user requirements 42 before or after an initial search is completed, and may thereby continue to limit the output 38 of the search 44.

The user may evaluate the real estate information presented in the display 18 once the display 18 presents the output 38 of the search in the heat map. Each cell 36 displays a numerical representation of the total number of properties having the appropriate objective data for that cell 36. Additionally, the background 40 of each cell 36 displays the color or degree of shading associated with the percentage of the total number of properties having the appropriate objective data for that cell 36.

It should be understood that the cells 36 displaying the higher total number of properties and the background 40 having a darker shading is representative of a more common or fair market value and range of additional costs for a particular geographic location. Thus, the heat map of the present disclosure allows the user to quickly identify fair market value. The user will also be able to identify outlier properties having an uncommon value or excessive additional costs by locating the cells 18 that display a lower total number of properties, and which have a background 40 with lighter shading.

Once the user identifies the cells 18 that represent the most desirable properties, the user may click on the cell 36 and be directed to a website or webpage that includes a more detailed analysis of the properties. Additional information included in the more detailed analysis includes, but is not limited to, contact information for the representative real estate agent, property descriptions, and pictures.

There are a number of advantages to using the above-described system 10 and method. First, the real estate information provided by the heat map on the display 18 is easy to evaluate using the first axis 24, the second axis 30, and the cells 36. Second, the user is able to limit the properties using the user requirements 42 in order to eliminate properties from the output 38 that do not include characteristics desired by the user such as a particular number of bedrooms, for example. Third, the heat map on the display 18 presents a wide range of information including common versus uncommon property values and costs associated with the properties in a particular geographic area. As a result, the user is able to identify properties for sale at a fair market value and properties that are overly expensive and/or that have excessive additional costs associated with them.

While certain representative embodiments and details have been shown for purposes of illustrating the invention, it will be apparent to those skilled in the art that various changes may be made without departing from the scope of the disclosure, which is further described in the following appended claims.

What is claimed is:

1. A system for displaying real estate information, comprising:
a display on which a heat map is presented, the heat map generated from at least one database, the at least one database including objective data about a plurality of real estate properties, and the heat map providing a comparative market analysis for at least one user requirement selected by an end user.

2. The system of claim 1, wherein the system includes a server having a processor for executing instructions to present the real estate information, and a memory including the at least one database in communication with the processor, the display and an input device in communication with the processor via a network, the input device permitting the end user to generate the display based on the objective data stored in the database.

3. The system of claim 1, wherein the heat map includes a first axis representing a range of property values of the plurality of real estate properties and a second axis representing a range of additional costs associated with the plurality of real estate properties.

4. The system of claim 1, wherein the system presents the at least one user requirement based on the objective data that may be selected by the end user.

5. The system of claim 4, wherein the at least one user requirement includes at least one of a geographic location of the plurality of real estate properties, the range of property values of the plurality of real estate properties, the range of additional costs associated with the plurality of real estate properties, a desired square footage of each of the plurality of real estate properties, a number of bedrooms included in each of the plurality of real estate properties, and a number of bathrooms included in each of the plurality of real estate properties.

6. The system of claim 3, wherein each property of the plurality of real estate properties is a residential home, and wherein the range of property values is based on an asking or sale price of each property divided by a square footage of each property, and the range of additional costs is based on one of an annual tax amount for each property and the annual tax amount for each property divided by the square footage of each property.

7. The system of claim 3, wherein each property of the plurality of real estate properties is a condominium, and wherein the range of property values is based on an asking or sale price of each property divided by a square footage of each property, and the range of additional costs is based on one of a monthly maintenance fee for each property and monthly maintenance fee for each property divided by the square footage of each property.

8. The system of claim 3, wherein the first axis is divided into a plurality of rows and the second axis is divided into a plurality of columns, and wherein a cell is formed at each of a plurality of positions where one of the plurality of rows intersects with one of the plurality of columns, and wherein the cell displays an output representing a total number of properties having a corresponding property value along the first axis and a corresponding additional costs along the second axis.

9. The system of claim 8, wherein a higher value of the output is indicative of the properties having a fair market value, and a lower value of the output is indicative of the properties having an outlier value.

10. The system of claim 8, wherein each of the cells has a background, with a darker shading of the background indicative of the properties having a more common value, and a lighter shading of the background indicative of the properties having an outlier value.

11. A system for displaying real estate information, comprising:
a server having a processor for executing instructions to present the real estate information, and a memory in communication with the processor and having at least one database with the real estate information; and
a user interface including a display and an input device, the display and the input device in communication with the processor via a network, the display presenting the real estate information in the form of a heat map, the heat map having a first axis representing a range of property values of a plurality of real estate properties and a second axis representing a range of additional costs associated with the plurality of real estate properties, the input device permitting an end user to generate the heat map based on the real estate information stored in the database and one or more user requirements based on the objective data that may be selected by the end user.

12. The system of claim 11, wherein each property of the plurality of real estate properties is a residential home, and wherein the range of property values is based on an asking or sale price of each property divided by a square footage of each property, and the range of additional costs is based on one of an annual tax amount for each property and the annual tax amount for each property divided by the square footage of each property.

13. The system of claim 11, wherein each property of the plurality of real estate properties is a condominium, and wherein the range of property values is based on an asking or sale price of each property divided by a square footage of each property, and the range of additional costs is based on one of a monthly maintenance fee for each property and the monthly maintenance fee for each property divided by the square footage of each property.

14. The system of claim 11, wherein the first axis is divided into a plurality of rows and the second axis is divided into a plurality of columns, and wherein a cell is formed at each of a plurality of positions where one of the plurality of rows intersects with one of the plurality of columns, and wherein the cell displays an output representing a total number of properties having a corresponding property value along the first axis and a corresponding additional costs along the second axis.

15. The system of claim 14, wherein a higher value of the output is indicative of the properties having a more common value, and a lower value of the output is indicative of the properties having an outlier value.

16. The system for displaying real estate property values of claim 14, wherein each of the cells has a background, and wherein a darker shading of the background is indicative of the properties having a more common value and a lighter shading of the background is indicative of the properties having an outlier value.

17. A method for displaying real estate information, the method comprising the steps of:
permitting an end user to select one or more user requirements relating to a plurality of real estate properties;
performing a search of a database including objective data for the plurality of real estate properties based on the user requirements; and
generating a heat map displaying the real estate information based on results from the search of the database, the heat map including a first identifying characteristic represented on a first axis and a second identifying characteristic represented on a second axis.

18. The method of claim 17, further including the step of determining at least the first identifying characteristic and the second identifying characteristic for plurality of real estate properties, wherein the first identifying characteristic includes a range of property values for each property of the plurality of real estate properties, and the second identifying characteristic includes a range of additional costs associated with each property of the plurality of real estate properties.

19. The method of claim 17, wherein each property of the plurality of real estate properties is a residential home, and wherein the range of property values is based on a sale price of each property divided by a square footage of each property, and the range of additional costs is based on one of an annual tax amount for each property and the annual tax amount for each property divided by the square footage of each property.

20. The method of claim 17, wherein each property of the plurality of real estate properties is a condominium, and wherein the range of property values is based on an asking or sale price of each property divided by a square footage of each property, and the range of additional costs is based on one of a monthly maintenance fee for each property and the monthly maintenance fee for each property divided by the square footage of each property.
